(19) United States
(12) Patent Application Publication
(10) Pub. No.: US 2007/0068315 A1
(43) Pub. Date: Mar. 29, 2007

(54) Bicycle shift operation device

(75) Inventor: Shinya Oseto, Sakai City (JP)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: Shimano Inc.

(21) Appl. No.: 11/455,287

(22) Filed: Jun. 16, 2006

(30) Foreign Application Priority Data
Sep. 15, 2005 (JP) 2005-268706

(51) Int. Cl. F16C 1/22; F16C 1/26

(52) U.S. Cl. 74/502.2; 74/502.6

(57) ABSTRACT

In a shift operation device, a shift position can be confirmed without moving one's eyes. A shift operation device 16 is a device mounted to a bicycle, and includes a fixed part 30, a movable part 32 and a shift position indication part 34. The fixed part 30 is mountable to the bicycle. The movable part 32 is movable with respect to the fixed part 30 and stoppable at positions corresponding to a plurality of shift positions of a shift device. The shift position indication part 34 has an index portion 40 which moves with the movable part 32, with its position recognizable by touch, and a reference portion 42 which is disposed at the fixed part 30 adjacently to the index portion 40, with its position recognizable by touch, and allows at least one shift position of a rear derailleur 18 to be recognizable by touch according to the positions of the index portion 40 and the reference portion 42.

### FIELD OF THE INVENTION

The present invention relates to a shift operation device, and particularly relates to a bicycle shift operation device for performing a shift operation of a shift device which is mounted to a bicycle.

### BACKGROUND OF THE INVENTION

There are bicycles equipped with shift devices such as internal shift devices and external shift devices. The bicycles equipped with such shift devices are provided with shift operating devices integral with or separate from brake levers at handlebars. There are lever type shift operation devices and grip type shift operation devices. The conventional lever type shift operation devices each have a fixed part mounted to the handlebar, a winding body which is rotatably mounted to the fixed part and winds up a shift cable, and a positioning mechanism which has a winding operation lever and a releasing operation lever, and positions the winding body (for example, see Japanese Patent Laid-Open No. 8-318888).

The conventional grip type shift operation devices each have a fixed part mounted to the handlebar, a rotating operation part rotatably mounted to the fixed part, a winding body disposed between the fixed part and the rotating operation part, and a positioning mechanism which positions the winding body (for example, see Japanese Patent Laid-Open No. 2004-352237).

The conventional shift operation devices of both types are provided with shift position display parts so that the shift positions can be visually confirmed. In the lever type shift operation devices, the shift position display parts are constructed by indicators which move with the winding bodies. In the grip type shift operation devices, the shift position display parts are constructed by numerals and graphics drawn on the outer peripheral surfaces of the fixed parts and the rotating operation parts.

In the above-described conventional constructions, in the case of confirming the shift positions of the shift operation devices, the shift positions are visually confirmed by looking at the positions of the indicators, numerals, graphics and the like of the shift display parts. Therefore, in order to confirm the shift positions, one has to confirm the shift position by turning one's eyes to the shift position display part from the view in the traveling direction.

### SUMMARY OF THE PREFERRED EMBODIMENTS

An object of the present invention is to make it possible to confirm a shift position without turning one's eyes when using a shift operation device or shifter.

In accordance with a first aspect of the present invention, there is provided a bicycle shift operation device that is mounted to a bicycle, and includes a fixed part, a movable part and a shift position indication part. The fixed part is mountable to the bicycle. The movable part is movable with respect to the fixed part and stoppable at a plurality of positions corresponding to a plurality of shift positions of a shift device. The shift position indication part has an index portion which moves with the movable part, with its position recognizable by touch, and a reference portion which is disposed at the fixed part adjacently to the index portion, with its position recognizable by touch, and allows at least one shift position of the shift device to be recognizable by touch according to the positions of the index portion and the reference portion.

In this shift operation device, when the movable part moves, the index portion moves with it. As a result, the positional relationship between the index portion provided at the movable part and the reference portion provided at the fixed part changes. By recognizing this positional relationship by touch, the shift position can be confirmed. Since the moving index portion and the fixed reference portion can be recognized by touch in this case, the shift position of the shift device can be confirmed without turning one's eyes by discerning the positional relationship between the index portion and the reference portion by touch.

In preferred embodiments, the fixed part has a first cylindrical member mountable to a handlebar of the bicycle, the movable part has a second cylindrical member that is rotatably connected to the first cylindrical member and rotates around the handlebar, and the reference portion is formed on an outer peripheral surface of the first cylindrical member, and the index portion is formed on an outer peripheral surface of the second cylindrical member. In this case, in the grip type shift operation device which performs a shift operation by gripping the movable part provided at the handlebar, the shift position can be confirmed by touch of the hand or the finger that grips the handle bar and performs a shift operation, and therefore, the shift position can be confirmed without moving one's eyes and without changing the hand at a time of shift.

In other preferred embodiments, the fixed part has a bracket including a mounting portion mountable to a handlebar of the bicycle, the movable part has a third cylindrical member that is connected to a shift cable winding body rotatably mounted to the bracket via a transmission mechanism, and rotates around the handlebar, the index portion is formed at the third cylindrical member, and the reference portion is disposed at the mounting portion of the bracket to be close to the index portion. In this case, when the shift cable winding body rotates in response to the shift operation, the rotation is transmitted to the third cylindrical member via the transmission mechanism, the third cylindrical member rotates with respect to the mounting portion, the index portion moves in accordance with this, and the shift position can be confirmed according to the positional relationship with the reference portion provided at the fixed mounting portion. Therefore, in the lever type shift operation device in which the shift cable winding body is disposed at the position away from the mounting portion which is mounted to the handlebar, the shift position can be confirmed by touch of the hand or finger which grips the handlebar, and therefore, the shift position can be confirmed without moving one's eyes and without changing the hand during traveling.

In still other preferred embodiments, when the shift device is in any of the shift positions, the index portion and the reference portion are disposed at positions opposed to each other. In this case, in, for example, the shift position frequently used, an intermediate shift position, a top position, a low position or the like, the index portion and the reference portion are disposed at the positions opposed to each other, whereby the shift position is easily confirmed.

In further preferred embodiments, one index portion above-described and one reference portion above-described are provided. In this case, especially in the shift device having a small number of shift steps, the shift position can be visually recognized with the simple construction.

In other preferred embodiments, a plurality of the reference portions are provided to be spaced from each other in a moving direction of the index portion. In this case, a plurality of reference portions of which positions can be easily memorized since they do not move are available, and therefore, the shift position is easily confirmed even with a large number of shift steps.

In still other preferred embodiments, two reference portions above-described are provided to be spaced from each other in the moving direction of the index portion, when the shift device is in either a top position or a low position, the index portion is disposed at positions opposed to the two reference portions respectively. Since in this case, the index portion is opposed to the reference portions when the shift device is in either the top position or the low position, the top position and the low position are easily confirmed, and the shift positions between them are easily confirmed.

In other preferred embodiments, a plurality of index portions are provided. In this case, a plurality of index portions which move are provided, and therefore, the shift position can be known by touching all the index portions and reference portion. Especially in the case of the grip type, the operation is performed by gripping the movable part with, for example, a thumb and a forefinger, and therefore, the shift position can be confirmed at the same time when the shift operation is performed.

In further preferred embodiments, two index portions above-described are provided. When the shift device is in either the top position or the low position, the reference portion is disposed at positions opposed to the two index portions respectively. When the shift device is in either the top position or the low position, the index portions are opposed to the reference portion, and therefore, the top position and the low position are easily confirmed, and the shift positions between them are easily confirmed.

In still other preferred embodiments, the index portion and reference portion are formed to be protruded or recessed from the other portions. In this case, the index portion and the reference portion are formed to be protruded or recessed, and therefore, the index portion and the reference portion are easily confirmed by touch.

According to the present invention, the moving index portion and the fixed reference portion can be recognized by touch, and therefore, by discerning the positional relationship between the index portion and the reference portion by touch, the shift position of the shift device can be confirmed without moving one's eyes.

### BRIEF DESCRIPTION OF THE DRAWINGS

FIG. 1 is a side view of a bicycle on which a first preferred embodiment of a shift operation device according to the present invention is mounted;

FIG. 2 is a plan view of the rear shift operation device of FIG. 1 mounted on a handle bar;

FIG. 3 is a perspective view of the rear shift operation device of FIG. 1;

FIG. 4 is a sectional view taken along line IV-IV of FIG. 2;

FIG. 5 is a perspective view of a second preferred embodiment of a shift operation device according to the present invention;

FIG. 6 is a perspective view of a third preferred embodiment of a shift operation device according to the present invention;

FIG. 7 is a perspective view of a fourth preferred embodiment of a shift operation device according to the present invention;

FIG. 8 is a perspective view of a fifth preferred embodiment of a shift operation device according to the present invention; and

FIG. 9 is a perspective view of a sixth preferred embodiment of a shift operation device according to the present invention with portions of the interior of the device shown in phantom.

[Description of Symbols]

| | |
|---|---|
| 4 | handle bar |
| 15, 16 | front and rear shift operation device |
| 30, 130 | fixed part |
| 32, 132 | movable part |
| 34, 134 | shift position indication part |
| 36 | first cylindrical member |
| 38 | second cylindrical member |
| 40, 140 | index portion |
| 42, 142 | reference portion |
| 131 | bracket |
| 131a | mounting portion |
| 138 | third cylindrical member |
| 145 | shift cable winding body |
| 165 | transmission mechanism |

### DETAILED DESCRIPTION OF THE PREFERRED EMBODIMENTS

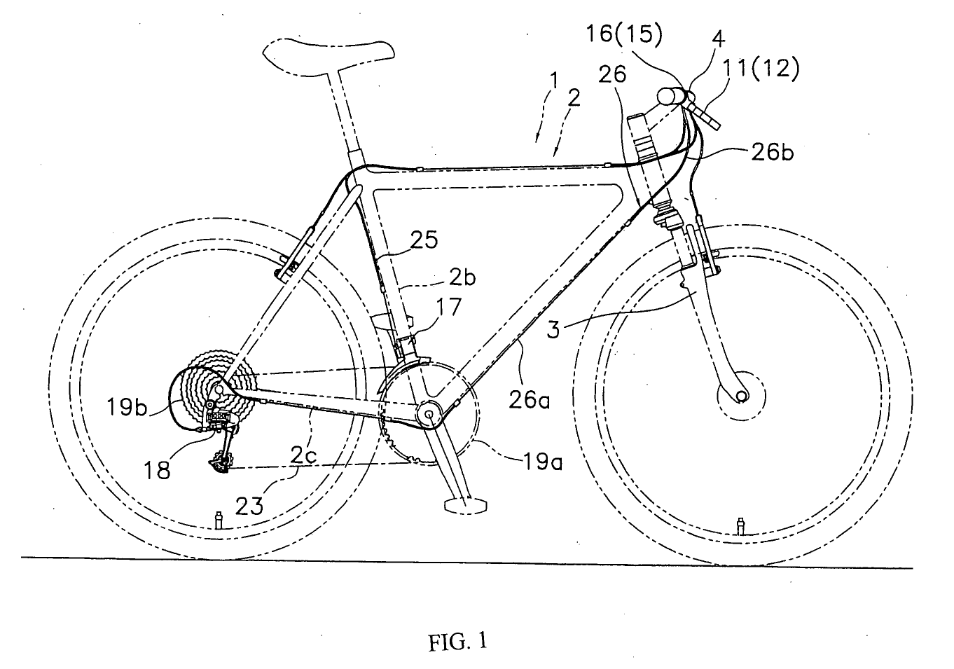

In FIG. 1, a bicycle 1 equipped with one embodiment of the present invention includes a frame 2 having a suspension fork 3, and a handlebar 4 fixed to an upper portion of the suspension fork 3. A front derailleur 17 constructing a shift device is mounted to an intermediate portion of the frame 2, and a rear derailleur 18 constructing the shift device is mounted to a rear end portion of the frame 2. The front derailleur 17 is disposed at a lower portion of a seat tube 2b of, for example, the frame 2, and guides a chain 23 to any of sprockets of a front chain wheel 19a having, for example, three sprockets. The rear derailleur 18 is disposed at a rear end portion of a chain stay 2c of the frame 2, and guides the chain 23 to any of the sprockets of a rear chain wheel 19b having, for example, seven sprockets. The front derailleur 17 and the rear derailleur 18 are connected to front and rear shift operation devices 15 and 16 via a front and a rear shift cables 25 and 26.

The front and rear shift operating devices 15 and 16 are constructed integrally with the brake levers 12 and 11 in the handlebar 4. The front shift operation device 15 and the rear shift operation device 16 are in the mirror image relationship, and have substantially the same construction and operation except for the number of shift steps, and therefore, only the rear shift operation device 16 will be described in the explanation of the construction and operation hereunder.

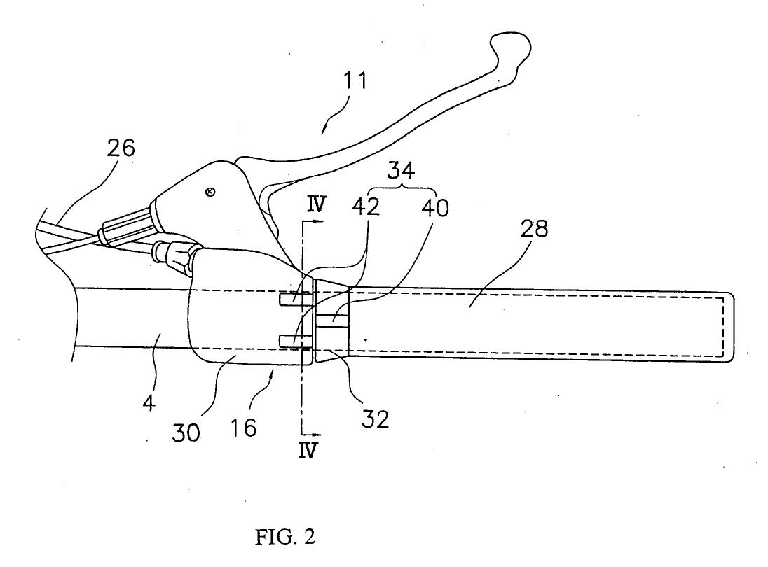

The rear shift operation device 16 has a fixed part 30 at which a bracket of the front brake lever 11 is integrally formed and which is mountable to the handlebar 4, a movable part 32 which is movable with respect to the fixed part 30 and stoppable at the positions corresponding to a plurality of (for example, seven) shift positions of the shift device, and a shift position indication part 34 which allows at least one shift position of the rear derailleur 18 as the shift device to be recognizable by touch as shown in FIG. 2. Outside the movable part 32, a grip 28 is mounted to the handlebar 4. The rear shift operation device 16 has a positioning mechanism 35 which positions the movable part 32 with respect to the fixed part 30 at the seven shift positions.

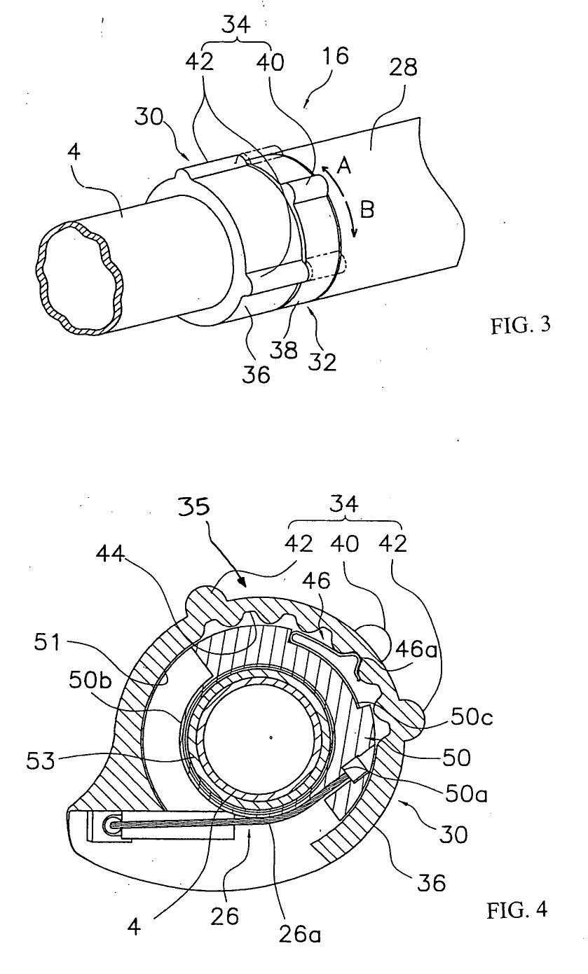

As schematically shown in FIG. 3, the fixed part 30 has a first cylindrical member 36 fixedly mountable to the handlebar 4. A cylindrical housing space 51 in which a shift cable winding body 50 integrally rotating with the movable part 32 is disposed, is formed inside the first cylindrical member 36 as shown in FIG. 4. At the center side in the diameter direction of the housing space 51, a cylindrical rotation support part 53 mounted to the handlebar 4 is formed.

The movable part 32 is disposed outside the fixed part 30 (the end portion side of the handlebar 4), and has a second cylindrical member 38 which is rotatably connected to the first cylindrical member 36, and rotates around a center axis of the handlebar 4. The second cylindrical member 38 is connected to the shift cable winding body 50 disposed in the housing space 51 of the fixed part 30 by connecting means not shown, and is constructed to operate integrally with this. The shift cable winding body 50 and the second cylindrical member 38 are rotatably supported at the rotation support part 53. An inner fixing part 50a at which a tip end of an inner cable 26a of the shift cable 26 is fixed, and a winding groove 50b by which the inner cable 26a is wound up are formed on an outer peripheral surface of the shift cable winding body 50.

As shown in FIGS. 3 and 4, the shift position indication part 34 has an index portion 40 which moves with the movable part 32, with its position recognizable by touch, and, for example, two reference portions 42 which are disposed at the fixed part 30 adjacently to the index portion 40, with their positions recognizable by touch. Specifically, the index portion 40 protrudes at the outer peripheral surface of the second cylindrical member 38 outward in the diameter direction from the other portion and is formed along the axial direction. The index portion 40 is formed so as to be disposed at the positions opposed to the two reference portions 42 when the rear derailleur 18 is in either a top position or a low position in this embodiment. Specifically, the index portion 40 is formed in substantially the same position in the circumferential direction as a protrusion 46a of a positioning spring 46 that will be described later of the positioning mechanism 35.

The two reference portions 42 are formed on the outer peripheral surface of the first cylindrical member 36. The two reference portions 42 are disposed to be spaced from each other in the moving direction of the index portion 40 provided at the movable part 32. Specifically, the reference portions 42 protrude outward in the diameter direction of the first cylindrical member 36 from the other portion and are formed along the axial direction. The reference portions 42 are disposed at the positions in the circumferential direction at a space corresponding to that of the two shift positions that are the low position and the top position of the rear derailleur 18. Specifically, the two reference portions 42 are respectively disposed at substantially the same positions in the circumferential direction as two positioning recesses 44 disposed at both ends of seven positioning recesses 44 that will be described later of the positioning mechanism 35. The positions of the index portion 40 and the reference portions 42 may be in any arrangement if only they are the same arrangement as the positional relationship of the positioning spring 46 and the positioning recesses 44, and they may be deviated from the positions of the positioning spring 46 and the positioning recesses 44.

The positioning mechanism 35 has, for example, the seven positioning recesses 44 which are formed on the inner peripheral surface of the housing space 51 corresponding to the shift positions, and the positioning spring 46 which is engaged in the positioning recesses 44, as shown in FIG. 4. The positioning recesses 44 are disposed on the inner peripheral surface of the housing space 51 to be spaced from each other in the circumferential direction. In FIG. 4, the positioning recesses 44 are drawn to be schematically equidistant, but the positioning recesses 44 are formed to be properly spaced from each other in accordance with the cable moving amount of the shift cable 26 for each shift position.

The positioning spring 46 is fitted in a fitting recess 50c that is formed at the position, which is opposed to the positioning recesses 44, on the outer peripheral surface of rotating fitting part 50 of the second cylindrical member 38. The positioning spring 46 is formed by folding a metal plate material having elasticity into a hairpin shape, and at its one end, a protrusion 46a which is engaged in the positioning recess 44 is formed to be curved. The protrusion 46a is biased to the positioning recess 44.

In the rear shift operation device 16 thus constructed, on the occasion of performing a shift operation, the outer peripheral surface of the second cylindrical member 38 is gripped with, for example, a thumb and a forefinger, and the movable part 32 is turned in either one of the cable winding direction A and the cable releasing direction B shown by the arrows in FIG. 3. For example, when it is turned in the cable winding direction A, the rear derailleur 18 is moved to the low position side, and when it is turned in the cable releasing direction B, the rear derailleur 18 is moved to the top position side. When the movable part 32 is turned to any one of the top position or the low position, the index portion 40 is located at the position opposed to the two reference portions 42.

In this case, the moving index portion 40 and the fixed reference portions 42 can be recognized by touch, and therefore, by recognizing the positional relationship of the index portion 40 and the reference portions 42 by touch, the shift position of the shift device (rear derailleur 18) can be confirmed by touch without moving one's eyes.

### Other Embodiments

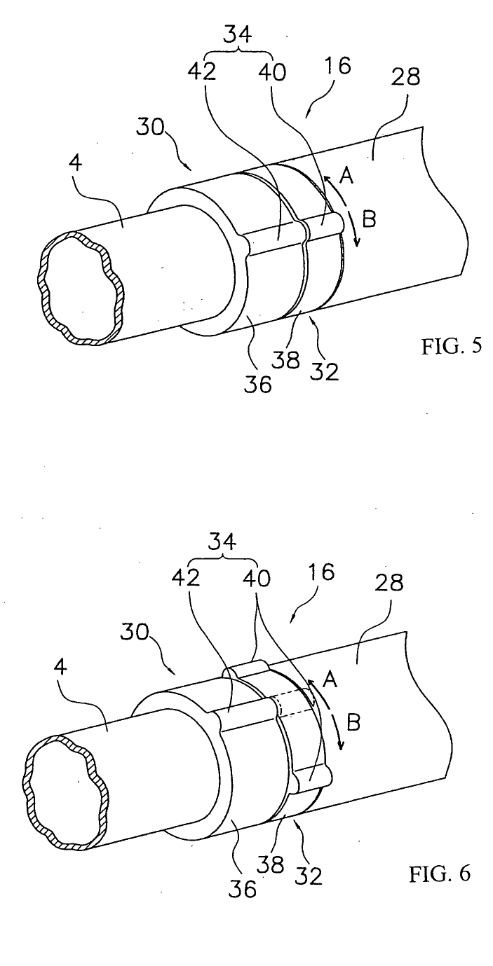

(a) In the above-described embodiment, two reference portions 42 are provided at the fixed part 30, and one index portion 40 is provided at the movable part 32, but, as shown in FIG. 5, one reference portion 42 and one index portion 40 may be provided. In this case, when the shift device (rear derailleur 18) is in any shift position (for example, the intermediate shift position, the top position and the low position), the index portion 40 and the reference portion 42 are preferably disposed at the positions opposed to each other.

As shown in FIG. 6, one reference portion 42 is provided at the fixed part 30, and two index portions 40 may be provided at the movable part 32. In this case, when the shift device is in either the top position or the low position, any one of the two index portions 40 and the reference portion 42 are preferably disposed at the positions opposed to each other.

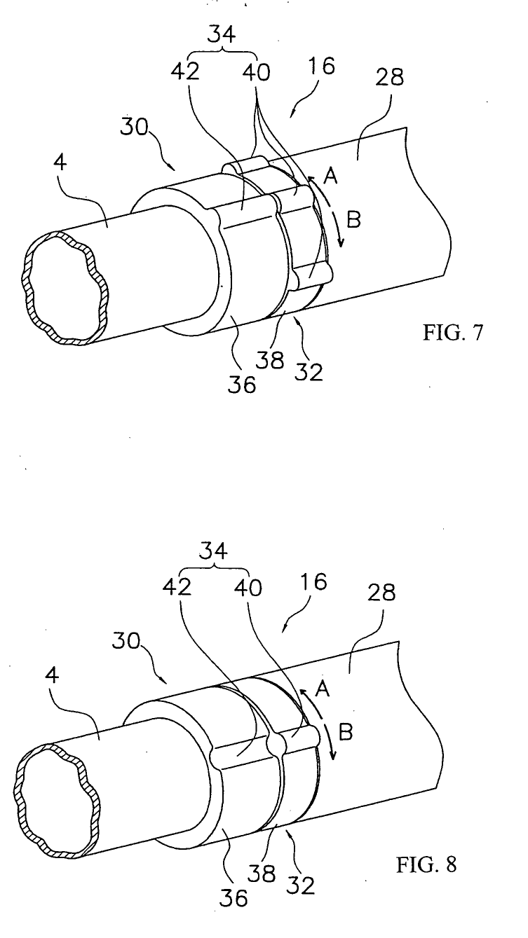

Further, as shown in FIG. 7, three or more index portions 40 may be provided with respect to one reference portion 42. On the other hand, three or more of reference portions 42 may be provided with respect to one index portion 40, and a plurality of index portions 40 and reference portions 42 may be provided respectively.

(b) In the above-described embodiment, the index portion 40 and the reference portion 42 are formed to be protruded from the other portions outward in the diameter direction from the outer peripheral surfaces of the second cylindrical member 38 and the first cylindrical member 36, respectively. However, the index portion and the reference portion of the present invention are not limited to those formed to be protruded. For example, as shown in FIG. 8, at least any one of the index portion 40 and the reference portions 42 may be formed to be recessed from the other portions. In FIG. 8, the reference portion 42 is formed to be recessed, but the index portion may be formed to be recessed from the other portions, and both of them may be formed to be recessed from the other portions.

(c) In the above-described embodiment, the present invention is described with the grip type shift operation device as an example, but the present invention is also applicable to a lever type shift operation device.

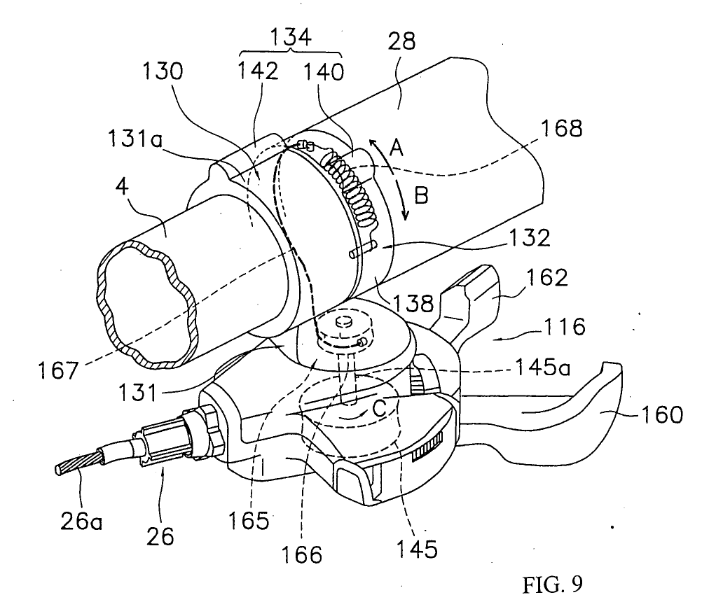

As shown in FIG. 9, a rear shift operation device 116 has a fixed part 130 mountable to the handlebar 4, a movable part 132 which is movable with respect to the fixed part 130 and stoppable at the positions corresponding to a plurality of shift positions of the shift device, and a shift position indication part 134 which allows at least one shift position of the rear derailleur 18 as the shift device to be recognizable by touch. The grip 28 is mounted on the handle bar 4 outside the movable part 132.

The fixed part 130 has a bracket 131 including a cylindrical mounting portion 131a mountable to the handlebar 4 of the bicycle.

The movable part 132 has a third cylindrical member 138 which is rotatably connected to the mounting portion 131a and rotates around the handlebar 4. The third cylindrical member 138 is connected to a shift cable winding body 145, which is rotatably mounted to the bracket 131, via a transmission mechanism 165 which will be described later. The rear shift operation device 116 has, for example, a lever-shaped winding operation member 160 and a releasing operation member 162 for rotating the shift cable winding body 145. The shift cable winding body 145 fixes the inner cable 26a of the shift cable 26, and is positioned to the rotation position corresponding to the shift position of the rear derailleur 18 by a positioning mechanism not shown.

The rear shift operation device 116 further has a transmission mechanism 165 which is disposed between the shift cable winding body 145 and the third cylindrical member 138, moves in response to the rotation of the shift cable winding body 145, and rotates the third cylindrical member 138 with the shift cable winding body 145. The transmission mechanism 165 has a rotary body 166 which is provided in the bracket 131 to rotate with the shift cable winding body 145, a transmission cable 167 with one end fixed to the rotary body 166 and the other end fixed to the third cylindrical member 138, and a coil spring 168 with one end fixed to the third cylindrical member 138 and the other end fixed to the mounting portion 131a. The rotary body 166 is mounted to a rotary shaft 145a of the shift cable winding body 145 to be incapable of rotating, and integrally rotates with the shift cable winding body 145. The transmission cable 167 is constructed to be wound on the rotary body 166 and wound up by the third cylindrical member 138. The coil spring 168 biases the third cylindrical member 138 in the cable releasing direction B.

The shift position indication part 134 has an index portion 140 which moves with the movable part 132 with its position recognizable by touch, and a reference portion 142 which is disposed at the fixed part 130 adjacently to the index portion 140 with its position recognizable by touch. The index portion 140 is formed at the third cylindrical member 138 and the reference portion 142 is disposed at the mounting portion 131a of the bracket 131 to be close to the index portion 140. The index portion 140 and the reference portion 142 may be formed to be protruded or formed to be recessed. In FIG. 9, one index portion 140 and one reference portion 142 are provided, but as described above, a plurality of at least one of them may be provided.

In the lever type rear shift operation device 116 with such a construction, when the shift cable winding body 145 is rotated in the cable winding direction C by operating the winding operation member 160, the rotary body 166 rotates in the same direction with it, and pulls the transmission cable 167 to rotate the third cylindrical member 138 in the cable winding direction A. Thereby, the index portion 140 also moves in the cable winding direction A. On the other hand, when the shift cable winding body 145 is rotated in the cable releasing direction by the release operation member 162, the transmission cable 167 is loosened, and the third cylindrical member 138 rotates in the cable releasing direction B by the coil spring 168, and the index portion 140 also moves in the cable releasing direction in response to this.

With such a construction, the same operational effect as the above-described embodiment can be provided.

In the lever type shift operation device, when the winding operation member moves with the shift cable winding body, the reference portion may be provided at the bracket, and the index portion may be provided at the winding operation member.

(d) In the above-described embodiment, the present invention is described with the shift operation device provided at the handlebar integrally with the brake lever as an example, but a shift operation device which is mounted on the handlebar separately from the brake lever is also included in the present invention.

(e) In the above-described embodiment, the present invention is described with the shift operation device which performs a shift operation of the external shift device having the front 17 and the rear derailleur 18 as an example. However, the shift device operated by the shift operation device of the present invention is not limited to the external shift device. The present invention is also applicable to a shift device having an internal shift hub, and a device which performs a shift operation of a shift device having a rear derailleur and an internal shift hub, for example.

What is claimed is:

1. A bicycle shift operation device that is mounted to a bicycle, comprising:
a fixed part mountable to said bicycle;
a movable part movable with respect to said fixed part and stoppable at a plurality of positions corresponding to a plurality of shift positions of a shift device; and
a shift position indication part that has an index portion which moves with said movable part, with its position recognizable by touch, and a reference portion which is disposed at said fixed part adjacently to the index portion, with its position recognizable by touch, and allows at least one shift position of the shift device to be recognizable by touch according to the positions of the index portion and the reference portion.

2. The bicycle shift operation device according to claim 1,
wherein said fixed part has a first cylindrical member mountable to a handlebar of said bicycle,
wherein said movable part has a second cylindrical member that is rotatably connected to the first cylindrical member and rotates around the handlebar,
wherein the reference portion is formed on an outer peripheral surface of the first cylindrical member, and
wherein the index portion is formed on an outer peripheral surface of the second cylindrical member.

3. The bicycle shift operation device according to claim 1,
wherein said fixed part has a bracket including a mounting portion mountable to a handlebar of said bicycle,
wherein said movable part has a third cylindrical member that is connected to a shift cable winding body rotatably mounted to the bracket via a transmission mechanism, and rotates around the handlebar,
wherein the index portion is formed at the third cylindrical member, and
wherein the reference portion is disposed at the mounting portion of the bracket to be close to the index portion.

4. The bicycle shift operation device according to claim 1,
wherein when the shift device is in any of the shift positions, the index portion and the reference portion are disposed at positions opposed to each other.

5. The bicycle shift operation device according to claim 2,
wherein one said index portion and one said reference portion are provided.

6. The bicycle shift operation device according to claim 1,
wherein a plurality of the reference portions are provided to be spaced from each other in a moving direction of the index portion.

7. The bicycle shift operation device according to claim 6,
wherein two said reference portions are provided to be spaced from each other in the moving direction of the index portion,
wherein when the shift device is in either a top position or a low position, the index portion is disposed at positions opposed to the two reference portions respectively.

8. The bicycle shift operation device according to claim 1,
wherein a plurality of index portions are provided.

9. The bicycle shift operation device according to claim 8,
wherein two said index portions are provided, and when the shift device is in either the top position or the low position, the reference potion is disposed at positions opposed to the two index portions respectively.

10. The bicycle shift operation device according to claim 1,
wherein one of the index portion and reference portion is a protrusive portion and the other of the index portion or the reference portion is a recessed portion.

11. The bicycle shift operation device according to claim 3,
wherein when the shift device is in any of the shift positions, the index portion and the reference portion are disposed at positions opposed to each other.

12. The bicycle shift operation device according to claim 3,
wherein a plurality of index portions are provided.

13. The bicycle shift operation device according to claim 11,
wherein one of the index portion and reference portion is a protrusive portion and the other of the index portion or the reference portion is a recessed portion.

14. A shift operation device that is adapted to be mounted to a bicycle, the shift operation device comprising:
a fixed part that is adapted to be mounted to the bicycle;
a movable part that is movable with respect to the fixed part to a plurality of positions that correspond to a plurality of shift positions of a shift device that is associated with the bicycle; and
a shift position indication part that includes an index portion that moves with the movable part, and a reference portion that is disposed on the fixed part and is adjacent to the index portion, whereby a user can recognize by touch at least one predetermined arrangement of the index portion with respect to the reference portion to help the user recognize what shift position the shift device is in.

15. The shift operation device of claim 14,
wherein the fixed part includes a first cylindrical member that is adapted to be mounted to a handlebar of the bicycle,
wherein the movable part includes a second cylindrical member that is rotatably connected to the first cylindrical member and is adapted to rotate around the handlebar,
wherein the reference portion is formed on an outer peripheral surface of the first cylindrical member, and
wherein the index portion is formed on an outer peripheral surface of the second cylindrical member.

16. The shift operation device of claim 14,
wherein the fixed part includes a bracket that has a mounting portion that is adapted to be mounted to a handlebar of the bicycle,
wherein the movable part includes a cylindrical member rotatably mounted to the bracket via a transmission mechanism,
wherein the movable member is adapted to rotate around the handlebar, and wherein cylindrical member is connected to a shift cable winding body,
wherein the index portion is disposed on the cylindrical member, and
wherein the reference portion is disposed on the mounting portion of the bracket and adjacent the index portion.

17. The shift operation device of claim 14, wherein movement of the movable part corresponds to movement of the shift device.

18. The shift operation device of claim 14 wherein the index portion protrudes from the movable part.

19. The shift operation device of claim 14 wherein the index portion is recessed into the movable part.

20. The shift operation device of claim 14 wherein the fixed part includes at least two reference portions, and wherein one reference portion corresponds to a top gear and another reference portion corresponds to a lowest gear.
